(19) United States
(12) Patent Application Publication
(10) Pub. No.: US 2012/0318477 A1
(43) Pub. Date: Dec. 20, 2012

(54) HEAT DISSIPATION DEVICE AND FASTENER THEREOF

(75) Inventors: XIANG-YANG YANG, Shenzhen City (CN); JING ZHANG, Shenzhen City (CN)

(73) Assignees: FOXCONN TECHNOLOGY CO., LTD., Tu-Cheng (TW); FU ZHUN PRECISION INDUSTRY (SHEN ZHEN) CO., LTD., Shenzhen City (CN)

(21) Appl. No.: 13/271,159

(22) Filed: Oct. 11, 2011

(30) Foreign Application Priority Data
Jun. 15, 2011 (CN) 201110160324.8

(51) Int. Cl. F28F 9/00; F16B 35/04

(52) U.S. Cl. 165/67; 411/401

(57) ABSTRACT

A fastener includes a fastening element, a fixture, and a spring. The fastening element includes a pole portion, a head portion extending from an end of the pole portion, and an engaging portion extending from another opposite end of the pole portion. The pole portion forms a flange on a periphery thereof. Blocks protrude outwardly from a periphery of the head portion. The fixture defines cutouts and buckling grooves therein, corresponding to the blocks of the fastening element. The blocks extend through the cutouts of the fixture and are rotated by an angle to be buckled in the buckling grooves. The spring circles the fastening element and is compressed between the flange and the fixture.

### BACKGROUND

1. Technical Field

The disclosure relates to heat dissipation devices and, more particularly, to a heat dissipation device with a fastener for fastening the heat dissipation device on a printed circuit board.

2. Description of Related Art

It is well known that, during operation of a computer, electronic devices such as central processing units (CPUs) frequently generate large amounts of heat. The heat must be quickly removed from the electronic device to prevent it from becoming unstable or being damaged. Typically, a heat sink is attached to an outer surface of the electronic device to absorb heat from the electronic device. The heat absorbed by the heat sink is then dissipated to ambient air.

In order to keep the heat sink in intimate contact with the electronic device, a fastener extends through the heat sink and a printed circuit board where the electronic device is located to fasten the heat sink to the electronic device. However, before the heat sink mounted on the electronic device, the fastener is usually pre-assembled on the heat sink by an annular collar which snaps with an end of the fastener extending beyond the heat sink, for facilitating transportation. However, the collar is prone to disengage from the fastener when subjected to an outer force during transportation, resulting in falling of the fastener from the heat sink.

What is needed, therefore, is a heat dissipation device with a fastener which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of a heat dissipation device in accordance with an embodiment of the disclosure.

FIG. 2 is an exploded view of the heat dissipation device of FIG. 1.

FIG. 3 is an exploded view of a fastener and an arm of the heat dissipation device of FIG. 2.

FIG. 4 is an assembled view of a fastener and an arm of the heat dissipation device of FIG. 2.

### DETAILED DESCRIPTION

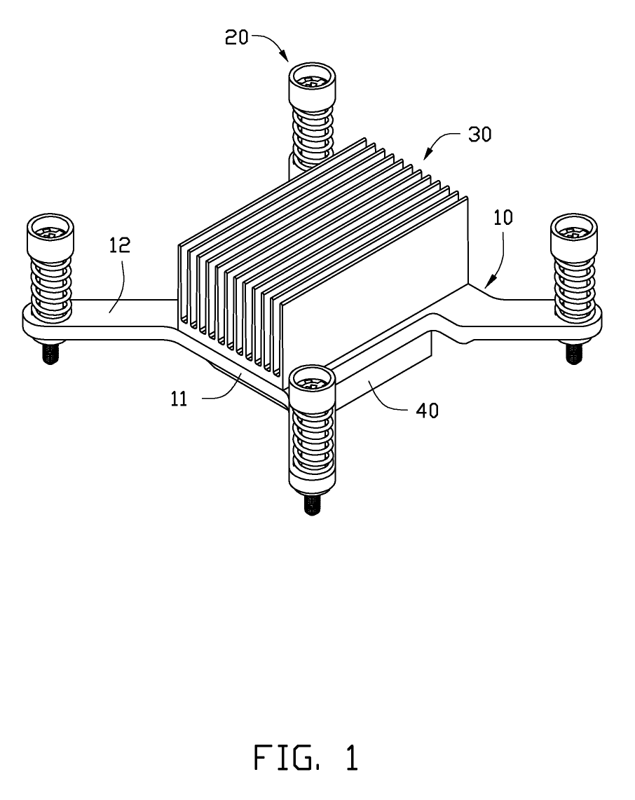

Referring to FIG. 1, a heat dissipation device in accordance with an embodiment of the disclosure is shown. The heat dissipation device is for dissipating heat generated by an electronic device 40 mounted on a printed circuit board (not shown). The heat dissipation device includes a conductive plate 10, a fin group 30 arranged on the conductive plate 10, and four fasteners 20 for fastening the heat dissipation device on the printed circuit board.

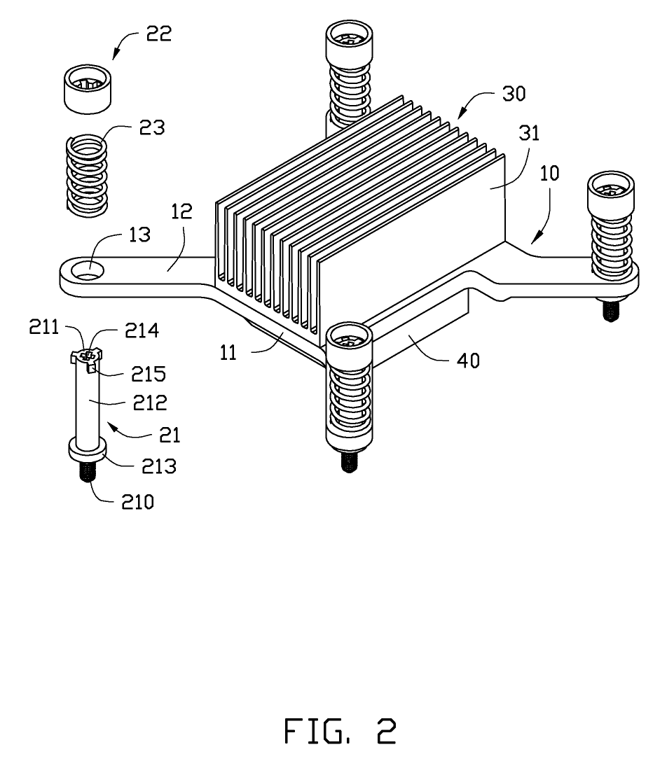

Also referring to FIG. 2, the conductive plate 10 includes a rectangular body 11 and four arms 12 extending from four corners of the body 11. A bottom face of the body 11 thermally contacts the electronic device 40. Each of the arms 12 defines a circular through hole 13.

The fin group 30 is made of metal such as aluminum, copper or an alloy thereof. The fin group 30 is connected to a top face of the body 11 of the conductive plate 10, and comprises a plurality of fins 31 connected together.

Each of the fasteners 20 comprises a fastening element 21, a spring 23 circling the fastening element 21, and a fixture 22.

The fastening element 21 comprises a cylindrical pole portion 212, a head portion 211 extending from a top end of the pole portion 212, and a cylindrical engaging portion 210 extending from an opposite bottom end of the pole portion 212. The engaging portion 210 is cylindrical and defines a plurality of threads on a periphery thereof. The pole portion 212 has a diameter larger than that of the engaging portion 210. The diameter of the pole portion 212 is smaller than an inner diameter of the spring 23, so that the spring 23 can encircle the pole portion 212. The head portion 211 defines an operating groove 214 in a top face thereof for facilitating operation of a tool such as a screwdriver to fasten the fastener 20 to the printed circuit board. Three rectangular blocks 215 protrude outwardly and radially from a periphery of the head portion 211. The blocks 215 are spaced from each other with a same interval. The pole portion 212 forms a circumferential flange 213 adjacent to the engaging portion 211. The flange 213 has a diameter larger than that of the through hole 13 of the conductive plate 10.

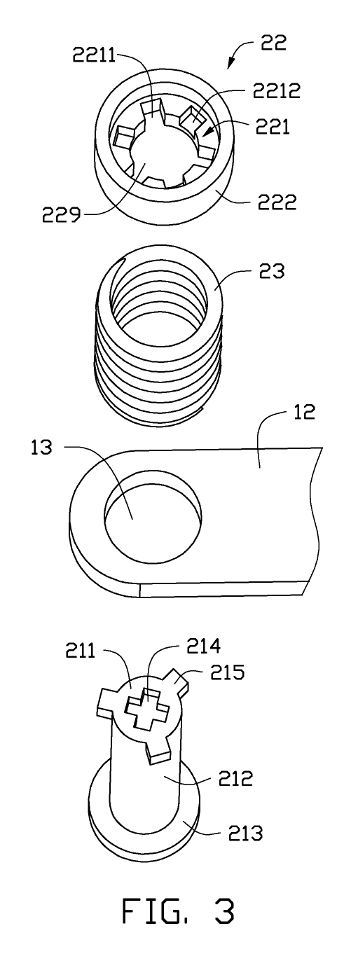

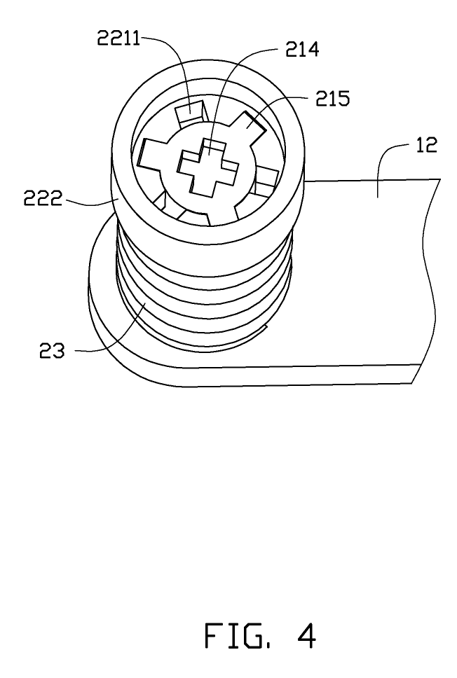

Also referring to FIGS. 3-4, the fixture 22 comprises an annular locating portion 221 defining a through hole 229 in a center thereof with a diameter substantially equal to the head portion 211 of the fastening element 21, and an annular side wall 222 extending upwardly from a top face of the locating portion 221. The locating portion 221 has an outer diameter larger than the inner diameter of the spring 23. The locating portion 221 defines three rectangular cutouts 2211 and three rectangular buckling grooves 2212 around the through hole 229, corresponding to the blocks 215 of the fastening element 21. The cutouts 2211 and the buckling grooves 2212 communicate with the through hole 229 of the locating portion 221. The cutouts 2211 and the buckling grooves 2212 are alternately distributed, and are spaced from each other with a same interval. Each of the cutouts 2211 has a depth equal to a thickness of the locating portion 221, i.e., each cutout 2211 extends through the locating portion 221. Each of the buckling grooves 2212 has a depth less than the thickness of the locating portion 221, i.e., each buckling groove 2212 is just defined in the locating portion 221 and has a bottom provided by the locating portion 221.

In assembly, the head portion 211 of the fastening element 21 extends through the through hole 13 of the conductive plate 10 from bottom to top of a corresponding arm 12 of the conducting plate 10. The spring 23 is sleeved on the pole portion 212 of the fastening element 21 and rests on the arm 12. The flange 213 and the spring 23 are respectively located at two sides of the conductive plate 10. The blocks 215 of the fastening element 21 extend through the cutouts 2211 of the fixture 22. The fixture 22 is rotated an angle, so that the blocks 215 of the fastening element 21 are buckled in the buckling grooves 2212 of the fixture 22. The spring 23 is compressed between the conductive plate 10 and the locating portion 221. Thus, the fastener 20 is fastened on the conductive plate 10 of the heat dissipation device.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A fastener for a heat dissipation device, comprising:
a fastening element comprising a pole portion, a head portion extending from an end of the pole portion, and an engaging portion extending from an opposite end of the pole portion, the pole portion forming a flange on a periphery thereof, the flange being adjacent to the engaging portion, a plurality of blocks protruding outwardly from a periphery of the head portion;
a fixture defining a plurality of cutouts and buckling grooves therein, corresponding to the blocks of the fastening element, the blocks extending through the cutouts of the fixture and being rotated by an angle to be buckled in the buckling grooves; and
a spring circling the fastening element and being located between the flange and the fixture.

2. The fastener of claim 1, wherein the blocks are spaced from each other with a same interval.

3. The fastener of claim 1, wherein the engaging portion is cylindrical and defines a plurality of threads on a periphery thereof.

4. The fastener of claim 1, wherein the head portion defines an operating groove for facilitating operation of a tool.

5. The fastener of claim 1, wherein the fixture comprises an annular locating portion defining a through hole in a center thereof, the cutouts and the buckling grooves being defined in the locating portion and communicating with the through hole of the locating portion.

6. The fastener of claim 5, wherein the cutouts and the buckling grooves are alternately distributed and spaced from each other with a same interval.

7. The fastener of claim 6, wherein the fixture further comprises an annular side wall extending upwardly from a top face of the locating portion.

8. The fastener of claim 5, wherein the locating portion has an outer diameter larger than the inner diameter of the spring.

9. The fastener of claim 5, wherein each of the cutouts has a depth equal to a thickness of the locating portion, each of the buckling grooves has a depth less than the thickness of the locating portion.

10. The fastener of claim 1, wherein the number of the blocks is equal to the number of the cutouts, and the number of the cutouts is equal to the number of the buckling grooves.

11. A heat dissipation device, comprising:
a conductive plate defining a through hole therein; and
a fastener, the fastener comprising:
a fastening element comprising a pole portion, a head portion extending from an end of the pole portion, and an engaging portion extending from another opposite end of the pole portion, the pole portion forming a flange on a periphery thereof, a plurality of blocks protruding outwardly from a periphery of the head portion, the blocks and the pole portion extending through the through hole of the conductive plate;
a fixture defining a plurality of cutouts and buckling grooves therein, corresponding to the blocks of the fastening element, the blocks extending through the cutouts of the fixture and being rotated by an angle to be buckled in the buckling grooves; and
a spring circling the fastening element and being compressed between the conductive plate and the fixture, the spring and the flange being located at two opposite sides of the conductive plate.

12. The heat dissipation device of claim 11, wherein the flange is blocked by the conducting plate to locate under the through hole of the conductive plate.

13. The heat dissipation device of claim 11, wherein the fixture comprises an annular locating portion defining a through hole in a center thereof, the cutouts and the buckling grooves being defined in the locating portion and communicating with the through hole of the locating portion.

14. The heat dissipation device of claim 13, wherein the cutouts and the buckling grooves are alternately distributed.

15. The heat dissipation device of claim 14, wherein the cutouts and the buckling grooves are spaced from each other.

16. The heat dissipation device of claim 14, wherein the fixture further comprises an annular side wall extending upwardly from a top face of the locating portion.

17. The heat dissipation device of claim 13, wherein each of the cutouts has a depth equal to a thickness of the locating portion, each of the buckling grooves has a depth less than the thickness of the locating portion.

18. The heat dissipation device of claim 11, wherein the number of the blocks is equal to the number of the cutouts, and the number of the cutouts is equal to the number of the buckling grooves.
